(19) United States
(12) Patent Application Publication
(10) Pub. No.: US 2009/0154288 A1
(43) Pub. Date: Jun. 18, 2009

(54) On-the-Fly Acid Blender with High-Rate, Single Pass, Emulsification Equipment

(76) Inventor: James F. Heathman, Katy, TX (US)

Correspondence Address: Paul Morico;BAKER BOTTS L.L.P., 910 Louisiana, Houston, TX, 77002-4995, US

(21) Appl. No.: 11/955,719

(22) Filed: Dec. 13, 2007

(51) Int. Cl. B01F 15/04

(52) U.S. Cl. 366/142; 366/181.8

(57) ABSTRACT

An improved method of blending emulsified well treatment fluids comprising providing a first centrifugal pump for pumping a first component of the emulsion well treatment fluid into a pipe; providing a first valve for controlling the flow of the first component of the emulsion well treatment fluid into the pipe; providing a second centrifugal pump for pumping a second component of the emulsion well treatment fluid into the pipe; providing a second valve for controlling the flow of the second component of the emulsion well treatment fluid into the pipe; providing an emulsion mixer loop coupled to the pipe for mixing the emulsion well treatment fluid; and controlling the pumps and the valves so as to control the ratio of the first component of the emulsion well treatment fluid to the second component of the emulsion well treatment fluid being delivered to the pipe.

### BACKGROUND

On-the-fly blending of well treatment fluids is not typically used for corrosive chemicals. Additionally, many such treatment fluids are emulsions. The use of emulsion treatment fluids such as emulsion acids has several advantages. For instance, an emulsion treatment fluid can be used to treat or stimulate deep into subterranean formations. Specifically, an emulsion treatment fluid can be used to treat or stimulate deeper formations because it can reach deeper into the formation before the emulsion breaks, exposing the treating or stimulating agents to the formation.

Generally, blending corrosive chemicals, otherwise known as acids, or hazardous chemicals, is done at a location other than the well site, using batch mixing. The chemicals are mixed in a tank at a bulk chemical plant and then transported to the well site. The mixing and the transportation are costly. Specialized transports are required to transport the mix. Additionally, specially trained personnel are required. In addition to being costly, this can be undesirably time consuming. Further, any real-time change to the mix presents problems, as an entire new batch must be mixed and transported. While this occurs, the job must wait, which can be extremely costly. Further, batch mixing requires that the tank be emptied prior to changing the mix. It is difficult to anticipate the exact amount of mix that will be required for a given application. This generally leads to excess mix left in the tank at the end of a job, or at a change point. Proper disposal of this mix can be environmentally hazardous, costly, and dangerous.

The above drawbacks are further exasperated when preparing an emulsion treatment fluid. The preparation of emulsified treatment fluids is more involved as the mixture must be sheared to retain its emulsion state. It is therefore desirable to be able to prepare emulsified treatment fluids on-the-fly at a satisfactory rate.

### FIGURES

Some specific example embodiments of the disclosure may be understood by referring, in part, to the following description and the accompanying drawings.

FIG. 1 is a system for on-the-fly blending of emulsion treatment fluids in accordance with an exemplary embodiment of the present invention.

FIG. 2 is a system for on-the-fly blending of emulsion treatment fluids in accordance with another exemplary embodiment of the present invention.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

The present invention is directed to blending fluids. Specifically, the present invention is directed to improved methods and systems of blending emulsified well treatment fluids at the well site.

In one exemplary embodiment, the present invention is directed to a method for blending an emulsion well treatment fluid, comprising: providing a first centrifugal pump for pumping a first component of the emulsion well treatment fluid into a pipe; providing a first valve for controlling the flow of the first component of the emulsion well treatment fluid into the pipe; providing a second centrifugal pump for pumping a second component of the emulsion well treatment fluid into the pipe; providing a second valve for controlling the flow of the second component of the emulsion well treatment fluid into the pipe; providing an emulsion mixer loop coupled to the pipe for mixing the emulsion well treatment fluid; and controlling the pumps and the valves so as to control the ratio of the first component of the emulsion well treatment fluid to the second component of the emulsion well treatment fluid being delivered to the pipe.

In another exemplary embodiment, the present invention is directed to a system for blending an emulsion well treatment fluid, comprising: a first centrifugal pump for pumping a first component of the emulsion well treatment fluid into a pipe; a first valve coupled to the first centrifugal pump for controlling the flow of the first component of the emulsion well treatment fluid into the pipe; a second centrifugal pump for pumping a second component of the emulsion well treatment fluid into the pipe; a second valve coupled to the second centrifugal pump for controlling the flow of the second component of the emulsion well treatment fluid into the pipe; an emulsion mixer loop coupled to the pipe for mixing the emulsion well treatment fluid; and means for controlling the pumps and the valves so as to control the ratio of the first component of the emulsion well treatment fluid to the second component of the emulsion well treatment fluid being delivered to the pipe.

The features and advantages of the present disclosure will be readily apparent to those skilled in the art upon a reading of the description of exemplary embodiments, which follows.

### DESCRIPTION

The present invention is directed to blending fluids. Specifically, the present invention is directed to improved methods and systems of blending emulsified well treatment fluids at the well site.

An improved method of blending the components of a well treatment fluid is disclosed in patent application Ser. No. 11/673,290 which is incorporated herein by reference in its entirety.

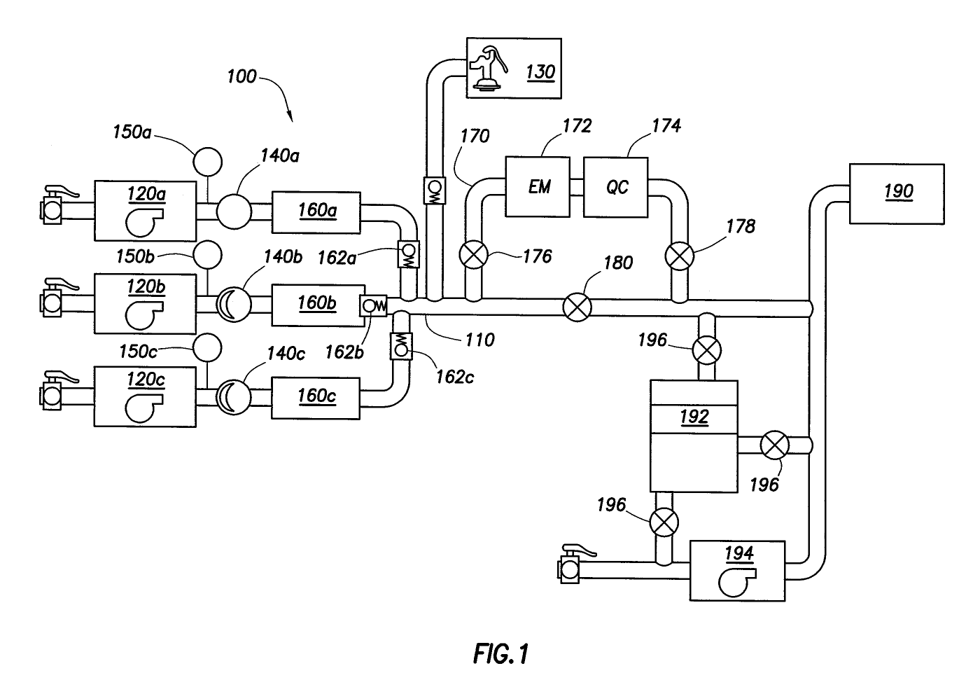

Referring now to FIG. 1, an exemplary embodiment of a system for preparing emulsified acids on-the-fly at a desired rate is depicted generally with reference numeral 100. The system 100 blends various components of the well treatment fluid directly into a pipe 110. This reduces or eliminates the need for standard mixing tanks or tubs. This may be accomplished using at least two centrifugal pumps 120 (shown as 120a, 120b, and 120c). The centrifugal pumps 120 may each pump a different component of the desired well treatment fluid.

As would be appreciated by those of ordinary skill in the art, with the benefit of this disclosure, more than two centrifugal pumps may be used to allow for more than two different components to be mixed together. For example, in one embodiment the system may include three centrifugal pumps for an acid treatment, where a first centrifugal pump may pump a hazardous chemical such as hydrochloric acid (“HCl”), a second centrifugal pump may pump water, and a third centrifugal pump may pump a highly corrosive chemical such as Ammonium Bi-Fluoride (“AF”). While HCl, water, and AF are disclosed, it should be understood that the chemicals may include any acid, hazardous chemical, corrosive, or other fluid. For instance, in another exemplary embodiment a non-aqueous fluid may be used as a primary flow stream. In one embodiment, the non-aqueous fluid may comprise diesel.

The system 100 may also include a number of valves 140 (shown as 140a, 140b, and 140c) for controlling the flow of the various components from the centrifugal pumps 120 into the pipe 110. The valves 140 may be butterfly valves, or any other valve suitable for use with well treatment fluids.

Between the centrifugal pumps 120 and the valves 140, the system 100 may include pressure transducers 150 (shown as 150a, 150b, and 150c) that act as pressure controls on the centrifugal pumps 120, preventing the centrifugal pumps 120 from pushing one another off line. Feedback from pressure transducers 150 may signal pressure set points in centrifugal pumps 120, such that the centrifugal pumps 120 maintain a desirable balance.

Between the valves 140 and the pipe 110, the system 100 may additionally include flow meters 160 (shown as 160a, 160b, and 160c) and check valves 162 (shown as 162a, 162b, and 162c) to monitor and control flow rates from the pumps 140.

Additional liquid additives may also be introduced into the pipe 110. The additives may be stored in liquid additive storage tanks (not shown), and pumped into the pipe 110 via one or more liquid additive pumps 130. While the liquid additive pump 130 is shown as a hand pump, the liquid additive pump 130 may be any type of pump, including, but not limited to, a positive displacement pump. One or more liquid additive valves (not shown) may be included to control the flow of liquid additives from the liquid additive pumps 130 into the pipe 110.

The well treatment fluid may be blended directly in the pipe 110, without the use of any tank. The flow rate and pressure of any of the components may be controlled by controlling the pumps 120 and 130 and the valves 140. This allows for the ratio of the various components and additives of the well treatment fluid to be modified as necessary for the specific field conditions at any given time. This modification can take place in real-time, allowing the desired well treatment fluid mix to be pumped into the well as it is needed.

Additionally, the system 100 may have a number of additional valves (not shown), with locations suitable for controlling flow in various ways as would be readily understood by one of ordinary skill in the art. For example, these additional valves may be butterfly valves, some of which are open and some of which are closed. In one exemplary embodiment, the additional valves may be used to address the mixing orders of some specific fluids by allowing a user to inject liquid additives into the raw product flow streams prior to entering the pipe 110.

In one embodiment, a mixer loop 170 is coupled to the pipe 110. The mixer loop 170 includes an emulsion mixer 172. The emulsion mixer 172 operates to provide high-quality emulsions on a single volumetric pass through the unit without having to recirculate or otherwise batch-mix the emulsified acid. As would be appreciated by those of ordinary skill in the art, a variety of mixers may be used to prepare the emulsion. In one embodiment, a mixer from Silverson Machines, Inc. of East Longmeadow, Mass., may be used in the system of the present invention. As would be appreciated by those of ordinary skill in the art, with the benefit of this disclosure, the emulsion mixer 172 may be made of any desirable material that best suits the system's use. In one embodiment, the emulsion mixer 172 may be made from Hastelloy, which can withstand corrosion and is well suited for mixers used to prepare acidic emulsions.

In one exemplary embodiment, the mixer loop includes a quality control unit 174 to evaluate the quality of the emulsion mix created by the emulsion mixer 172. As would be appreciated by those of ordinary skill in the art, with the benefit of this disclosure, a number of different methods may be utilized to evaluate the quality of the emulsion mixture.

In one embodiment, the quality control unit 174 comprises an Electrical Stability meter such as the Fann 23D available from Fann Instrument Company in Houston, Tex., which may be used to characterize the emulsion well treatment fluid formed. A sample of the emulsion created by the emulsion mixer 172 is placed between the electrodes of the Electrical Stability meter. The voltage applied to the Electrical Stability meter is then increased and the current between the electrodes is measured to determine the requisite voltage that can cause the emulsion to break. The greater the requisite voltage, the greater the stability of the emulsion formed. In another embodiment, the quality control unit 174 comprises a wettability meter. One such device is disclosed in statutory invention registration number U.S. H1932, which is incorporated herein by reference in its entirety. The wettability meter can likewise be used to evaluate the emulsion mixture with the measurement of a voltage indicating that the emulsion is not yet complete and includes a water external or bi-continuous state.

Valves 176, 178, and 180 may be used to control the flow of the fluids through the mixer loop 170 depending on the system requirements. For instance, when mixing fluids that are not to be emulsified, valves 176 and 178 may be closed and valve 180 can be opened to bypass the mixer loop 170, with the fluid mixture passing directly through the pipe 110. In contrast, in order to create an emulsion mixture, valves 176 and 178 are opened and valve 180 is closed, forcing the fluids to flow through the mixer 172 and the quality control unit 174.

A discharge flow meter 190 may be included in the system 100. This may allow for adjustments to be made to the pumps 120 and valves 140, such that the correct mix ratio is maintained without creating undesirable negative pressure in the system 100. After the mix has passed through the discharge flow meter 190, it may pass through another pump (not shown), which then pumps the mix downhole.

Computer software may be used to control the mix ratio. The computer software may include a pressure control system, a rate control system, and/or a concentration control system. The pressure control system may control pressure by controlling the pumps 120. The rate control system may control flow rate by controlling the valves 140. The concentration control system may control the concentration by controlling the pumps 120.

The pressure control system may include a drive signal to the centrifugal pumps 120 and feedback from pressure transducers 150. Each of the centrifugal pumps 120 may maintain a separate pressure set point. These pressure set points may be based on expected rate and resultant discharge pressure. The optimal pressure set point may place the valves 140 at a predetermined percentage open for each respective expected rate.

The rate control system may include a drive signal to each valve 140 and feedback from the respective flow meter 160. The valve 140 for a first (or master) component (e.g., water) may be set to 100% open and the rate may be set by the discharge rate, as measured by the discharge flow meter 190. The rate set points for the remaining valves 140 may be set by the concentration control system. Thus, as the requirements for concentrations change (even during a job), the operator has the ability to ramp up or down the concentration and/or liquid additives depending on the specific need. This may be a desirable alternative to the standard practice of mixing a new batch at the acid plant and transporting the mixture to the well site.

The concentration control system may include the rate control system and the rate feedback from the master (e.g., water) rate, which may be measured by the corresponding flow meter 160. Based on a predetermined well treatment fluid mix, the rate set points for the other components may be calculated from a concentration or parts per thousand of the master rate. As the master rate increases, the rate for the other components may also increase. The increasing rate of other components will slow the increasing master rate until the desired concentration is established.

The system 100 may optionally include additional components. For example, as shown in FIG. 1, the system 100 may include a tank 192. Due to the nature of the types of chemicals used, the tank 192 may be situated on the discharge side of the system 100. The tank 192 may be used to prevent loss if something goes wrong and the job must be stopped. Additionally, the tank 192 may be useful in situations where the flow rates are very low. As would be appreciated by those of ordinary skill in the art, with the benefit of this disclosure, additional valves 196 may be used to control the flow of the fluid through the tank 192. For example, these additional valves may be butterfly valves, some of which are open and some of which are closed.

The system 100 may also optionally include a discharge recirculation pump 194. The discharge recirculation pump 194 may serve two purposes. The first may be for recirculation. The second may be for discharge at very low flow rates. The recirculation pump 194 may be any type of pump for discharge recirculation (e.g., a 120 HP pump).

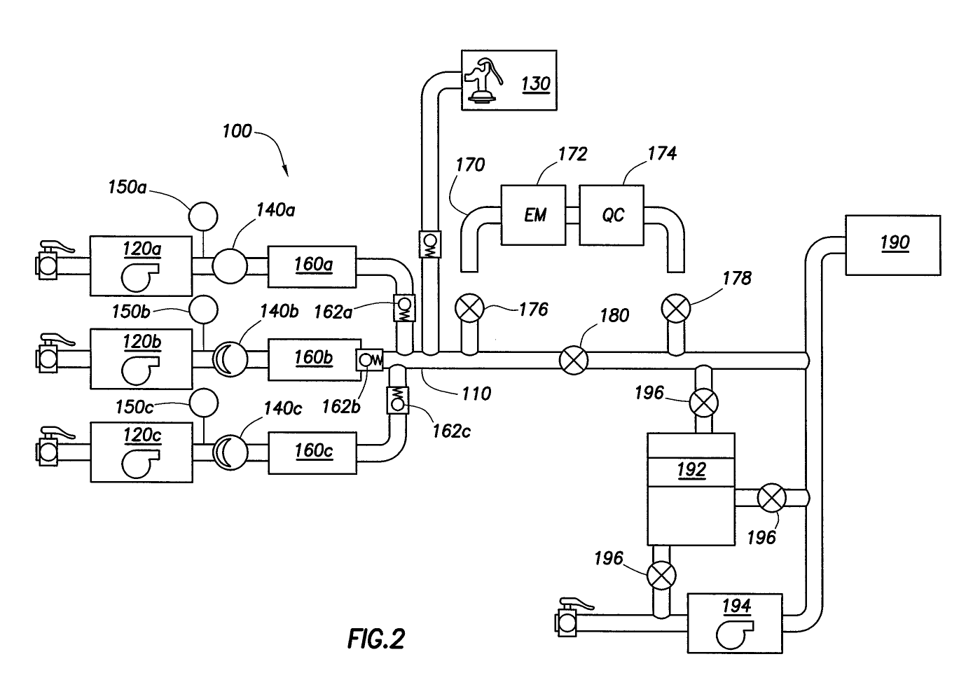

As would be appreciated by those of ordinary skill in the art, with the benefit of this disclosure, in another exemplary embodiment, the emulsion mixer 172 and the quality control unit 174 equipment may comprise a separate unit which is removably coupled to the system 100. FIG. 2 depicts a system in accordance with an exemplary embodiment of the present invention. The valves 176 and 178 may be initially closed. Once the emulsion mixer 172 and the quality control unit 174 are coupled to the system, the valves 176 and 178 may be opened to allow fluid flow through the mixer loop 170. Alternatively, in another exemplary embodiment (not shown), one of the emulsion mixer 172 or the quality control unit 174 is removably coupled to the system 100, while the other may not be removable from the system.

This system 100 may be used for acid blending for acidizing wells, otherwise known as “Acid-On-the-Fly,” which involves blending two or more major hazardous chemical components into a pressurized piping system and injecting one or more liquid additives into that flow stream. This system 100 may alternatively be used for fracturing operations, in which case the treatment fluid would be a fracturing fluid. Additionally, this system 100 may be used for drilling operations, in which case the treatment fluid would be drilling mud. Therefore, although the present invention is described in the context of emulsion acids, as would be appreciated by those of ordinary skill in the art, with the benefit of this disclosure, the system and methods of the present invention may also apply to non-acids that may need emulsification or other high-shear preparation on a single pass such as on-location preparation of emulsion based fracturing fluids, completion fluids, cementing fluids such as spacers, and drilling fluids.

As would be appreciated by those of ordinary skill in the art, with the benefit of this disclosure, the system and method of the present invention may also be used to prepare high-quality emulsified fluids offsite. Such high-quality emulsified fluids are stable and can be stored for extended periods of time or transported to location rather than having to be prepared on-site for immediate use due to a short stability period. For instance, the system and method of the present invention may be used to prepare acids at a typical acid blending plant in a field location. In an exemplary embodiment, the location for the preparation of a high-quality emulsified fluid may be an existing service plant or a temporary blending facility set up in a remote location in order to service a large multi-well operation.

The ability to blend “On-the-Fly” may reduce the amount of blended chemicals requiring disposal upon completion of the process. It may also lower exposure of hazardous chemicals to personnel and the environment. Furthermore, it may decrease the number of personnel required for the process and decrease the amount of time hazardous chemicals would be in use. Additionally, by blending the chemicals as they are pumped downhole, there may be a significant reduction of waste that must be disposed of, and cost associated with that disposal process. Further, there may be a reduction in cost for transporting the mixed chemicals, since that would no longer be a requirement. Additionally, there may be a reduction of cost for buying and maintaining the highly regulated cargo tank motor vehicles. Additionally, there may be a reduction and/or elimination of the bulk chemical plants (otherwise known as acid plants) currently being used. By eliminating bulk acid plants, transports, and the physical handling of these types of chemicals, the risk of personal and environmental exposure may be significantly reduced.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In addition, the terms in the claims have their plain, ordinary meaning unless otherwise explicitly and clearly defined by the patentee.

What is claimed is:

1. A method for blending an emulsion well treatment fluid, comprising:
providing a first centrifugal pump for pumping a first component of the emulsion well treatment fluid into a pipe;
providing a first valve for controlling the flow of the first component of the emulsion well treatment fluid into the pipe;
providing a second centrifugal pump for pumping a second component of the emulsion well treatment fluid into the pipe;
providing a second valve for controlling the flow of the second component of the emulsion well treatment fluid into the pipe;
providing an emulsion mixer loop coupled to the pipe for mixing the emulsion well treatment fluid; and
controlling the pumps and the valves so as to control the ratio of the first component of the emulsion well treatment fluid to the second component of the emulsion well treatment fluid being delivered to the pipe.

2. The method of claim 1, wherein the emulsion mixer loop comprises an emulsion mixer.

3. The method of claim 2, wherein the emulsion mixer loop comprises a quality control unit coupled to the emulsion mixer.

4. The method of claim 3, wherein the quality control unit comprises one of an electrical stability tester or a wettability meter.

5. The method of claim 1, further comprising providing a third valve for controlling the flow of the first component of the emulsion well treatment fluid and the second component of the emulsion well treatment fluid into the emulsion mixer loop.

6. The method of claim 1, further comprising:
providing at least one liquid additive storage tank;
providing at least one liquid additive pump; and
providing at least one liquid additive valve for controlling the flow of a liquid additive into the pipe;
wherein controlling the liquid additive pump and the liquid additive valve controls the ratio of the liquid additive to the other components of the emulsion well treatment fluid being delivered to the pipe.

7. The method of claim 1, further comprising
pumping the emulsion well treatment fluid from the pipe into the well.

8. The method of claim 1, wherein the emulsion well treatment fluid is one of an acidizing fluid, a fracturing fluid, a completion fluid, a cementing fluid or a drilling fluid.

9. The method of claim 1, further comprising bypassing the emulsion mixer loop if a non-emulsion well treatment fluid is desired.

10. The method of claim 1, wherein the emulsion mixer loop is removably coupled to the pipe.

11. The method of claim 1, wherein the controlling of the pumps and the valves is conducted by a computer system.

12. A system for blending an emulsion well treatment fluid, comprising:
a first centrifugal pump for pumping a first component of the emulsion well treatment fluid into a pipe;
a first valve coupled to the first centrifugal pump for controlling the flow of the first component of the emulsion well treatment fluid into the pipe;
a second centrifugal pump for pumping a second component of the emulsion well treatment fluid into the pipe;
a second valve coupled to the second centrifugal pump for controlling the flow of the second component of the emulsion well treatment fluid into the pipe;
an emulsion mixer loop coupled to the pipe for mixing the emulsion well treatment fluid; and
means for controlling the pumps and the valves so as to control the ratio of the first component of the emulsion well treatment fluid to the second component of the emulsion well treatment fluid being delivered to the pipe.

13. The system of claim 12, wherein the emulsion mixer loop comprises an emulsion mixer.

14. The system of claim 13, wherein the emulsion mixer loop comprises a quality control unit placed downstream of the emulsion mixer.

15. The system of claim 14, wherein the quality control unit comprises one of an electrical stability tester or a wettability meter.

16. The system of claim 12, further comprising:
a third centrifugal pump for pumping a third component of the well treatment fluid into the pipe; and
a third valve coupled to the third centrifugal pump for controlling the flow of the third component of the well treatment fluid into the pipe;
wherein the means for controlling the pumps and the valves further controls the ratio of the third component of the well treatment fluid to the other components of the well treatment fluid being delivered to the pipe.

17. The system of claim 12, further comprising a fourth valve for controlling the flow of the first component of the well treatment fluid and the second component of the well treatment fluid into the emulsion mixer loop.

18. The system of claim 12, further comprising:
at least one liquid additive storage tank;
at least one liquid additive pump coupled to the liquid additive storage tank;
at least one liquid additive valve for controlling the flow of a liquid additive from the liquid additive storage tank into the pipe; and
means for controlling the liquid additive pump and the liquid additive valve so as to control the ratio of the liquid additive to the other components of the emulsion well treatment fluid being delivered to the pipe.

19. The system of claim 12, further comprising
means for pumping the emulsion well treatment fluid from the pipe into the well.

20. The system of claim 12, wherein the emulsion well treatment fluid is one of an acidizing fluid, a fracturing fluid, a completion fluid, a cementing fluid or a drilling fluid.

21. The system of claim 12, further comprising a recirculating pump coupled to the pipe outlet for recirculating the emulsion well treatment fluid.
